(19) United States
(12) Patent Application Publication
(10) Pub. No.: US 2016/0379641 A1
(43) Pub. Date: Dec. 29, 2016

(54) Auto-Generation of Notes and Tasks From Passive Recording

(71) Applicant: MICROSOFT TECHNOLOGY LICENSING, LLC, Redmond, WA (US)

(72) Inventors: Jie Liu, Bellevue, WA (US); Mayuresh P. Dalal, San Jose, WA (US); Michal Gabor, Bellevue, WA (US); Gaurang Prajapati, Kirkland, WA (US)

(73) Assignee: MICROSOFT TECHNOLOGY LICENSING, LLC, Redmond, WA (US)

(21) Appl. No.: 14/874,663

(22) Filed: Oct. 5, 2015

Related U.S. Application Data
(63) Continuation of application No. 14/838,849, filed on Aug. 28, 2015.
(60) Provisional application No. 62/186,313, filed on Jun. 29, 2015.

(51) Int. Cl. G10L 15/26; G10L 17/02

(52) U.S. Cl. CPC G10L 15/265; G10L 17/02; G10L 2015/223

(57) ABSTRACT

Systems and methods, and computer-readable media bearing instructions for executing one or more actions associated with a predetermined feature detected in an ongoing content stream are presented. As the ongoing content stream is passively recorded, the content stream is monitored for any one of a plurality of predetermined features. Upon detecting a predetermined feature in the ongoing content stream, one or more actions associated the detected feature are carried out with regard to the recorded content in the passive recording buffer.

### CROSS-REFERENCE TO RELATED APPLICATIONS

This application is a continuation-in-part of U.S. patent application Ser. No. 14/838,849, titled “Annotating Notes From Passive Recording With User Data,” filed on Aug. 28, 2015, which is a continuation-in-part of U.S. patent application Ser. No. 14/678,611, titled “Generating Notes From Passive Recording,” filed Apr. 3, 2015, both of which are incorporated herein by reference. This application further claims priority to U.S. Provisional Patent Application No. 62/186,313, titled “Generating Notes From Passive Recording With Annotations,” filed Jun. 29, 2015, which is incorporated herein by reference. This application is related to co-pending U.S. patent application Ser. No. 14/832,144, titled “Annotating Notes From Passive Recording With Categories,” filed Aug. 21, 2015; U.S. patent application Ser. No. 14/859,291, titled “Annotating Notes From Passive Recording With Visual Content,” filed Sep. 19, 2015; and to U.S. patent application Ser. No. ______, titled “Capturing Notes From Passive Recording With Task Assignments,” filed ______, (attorney docket #357370.01).

### BACKGROUND

As most everyone will appreciate, it is very difficult to take handwritten notes while actively participating in an on-going conversation or lecture, whether or not one is simply listening or activity conversing with others. At best, the conversation becomes choppy as the note-taker must pause in the conversation (or in listening to the conversation) to commit salient points of the conversation to notes. Quite often, the note taker misses information (which may or may not be important) while writing down notes of a previous point. Typing one's notes does not change the fact that the conversation becomes choppy or the note taker (in typing the notes) will miss a portion of the conversation.

Recording an entire conversation and subsequently replaying and capturing notes during the replay, with the ability to pause the replay while the note taker captures information to notes, is one alternative. Unfortunately, this requires that the note taker invests the time to re-listen to the entire conversation to capture relevant points to notes.

Most people don't have an audio recorder per se, but often possess a mobile device that has the capability to record audio. While new mobile devices are constantly updated with more computing capability and storage, creating an audio recording of a typical lecture would consume significant storage resources.

### SUMMARY

The following Summary is provided to introduce a selection of concepts in a simplified form that are further described below in the Detailed Description. The Summary is not intended to identify key features or essential features of the claimed subject matter, nor is it intended to be used to limit the scope of the claimed subject matter.

Systems and methods, and computer-readable media bearing instructions for executing one or more actions associated with a predetermined feature detected in an ongoing content stream are presented. As the ongoing content stream is passively recorded, the content stream is monitored for any one of a plurality of predetermined features. Upon detecting a predetermined feature in the ongoing content stream, one or more actions associated the detected feature are carried out with regard to the recorded content in the passive recording buffer.

According to additional aspects of the disclosed subject matter, a computer-implemented method conducted on a user's computing device for executing an action with regard to a detected feature in an ongoing content stream is presented. The method comprises passively recording of an ongoing content stream, where the passive recording stores the recorded content of the ongoing content stream in a passive recording buffer. In addition to passively recording the ongoing content stream, the content stream is monitored for a predetermined feature. Upon detecting a predetermined feature in the ongoing content stream, an action associated with the predetermined feature is executed in regard to the recorded content in the passive recording buffer.

According to further aspects of the disclosed subject matter, a computer-readable medium bearing computer-executable instructions is presented. When the computer-executable instructions are executed on a computing system comprising at least a processor, the execution carries out a method for executing an action with regard to a detected feature in an ongoing content stream. The method comprises at least passively recording content of the ongoing content stream in a passive recording buffer. Additionally, monitoring is conducted with regard to a predetermined feature in the ongoing content stream. Upon detecting a predetermined feature, an action associated with the predetermined feature is carried out with regard to the recorded content in the passive recording buffer.

According to still further aspects of the disclosed subject matter, a user computing device for executing an action with regard to a detected feature in an ongoing content stream is presented. The computing device comprises a processor and a memory, where the processor executes instructions stored in the memory as part of or in conjunction with additional components to generate notes from an ongoing content stream. These additional components include at least a passive recording buffer, an audio recording component, a passive recording component, and a feature detection component. In operation, the audio recording component records content of the ongoing content stream and the passive recording component obtains the recorded content of the ongoing content stream from the audio recording component and stores the recorded content to the passive recording buffer. The feature detection component is configured to monitor the ongoing content stream for a predetermined feature. Upon detecting a predetermined feature in the ongoing content stream, an action associated with the predetermined feature is carried out with regard to the recorded content in the passive recording buffer.

### BRIEF DESCRIPTION OF THE DRAWINGS

The foregoing aspects and many of the attendant advantages of the disclosed subject matter will become more readily appreciated as they are better understood by reference to the following description when taken in conjunction with the following drawings, wherein:

FIG. 1A illustrate an exemplary audio stream (i.e., ongoing audio conditions) with regard to a time line, and further illustrates various the ongoing passive recording of the audio stream into an exemplary passive recording buffer;

FIG. 1B illustrates an alternative implementation (to that of FIG. 1A) in conducting the ongoing passive recording of an audio stream into a passive recording buffer;

FIG. 2 is a flow diagram illustrating an exemplary routine for generating notes of the most recently portion of the ongoing content stream;

FIG. 3 is a flow diagram illustrating an exemplary routine for generating notes of the most recently portion of the ongoing content stream, and for continued capture until indicated by a user;

FIG. 4 is a block diagram illustrating exemplary components of a suitably configured computing device for implementing aspects of the disclosed subject matter;

FIG. 5 is a pictorial diagram illustrating an exemplary network environment suitable for implementing aspects of the disclosed subject matter;

FIG. 6 illustrates a typical home screen as presented by an app (or application) executing on a suitably configured computing device;

FIG. 7 illustrates the exemplary computing device of FIG. 6 after the user has interacted with the “add meeting” control;

FIG. 8 illustrates the exemplary computing device of FIG. 6 after the user has switched to the presentation of categories as user-actionable controls for capturing the content of the passive recording buffer into a note in the note file and associating the corresponding category with the note as an annotation;

FIG. 9 illustrates the exemplary computing device showing the notes associated with “Meeting 4”;

FIG. 10 illustrates an exemplary routine for generating notes of the most recently portion of the ongoing content stream, for continued capture until indicated by a user, and for annotating the captured note with a predetermined category or tag;

FIG. 11 illustrates an exemplary routine for identifying and populating a people list corresponding to a current meeting;

FIGS. 12A-12C are pictorial diagrams illustrating an exemplary user interface on the computing device of FIG. 6 in regard assigning a task to a person and associating the task with a captured note;

FIG. 13 is a pictorial diagram illustrating an exemplary user interface on the computing device in which the user is able to view the status of the various notes associated with the meeting;

FIG. 14 is a flow diagram illustrating an exemplary routine for generating notes of the most recently passively recorded content of the ongoing content stream, for continued capture until indicated by a user, and for associating a task with the note;

FIG. 15 is a flow diagram illustrating an exemplary routine for associating a task assignment with a generated note;

FIG. 16 is a flow diagram illustrating an exemplary routine for a task management service to respond to a task record submission;

FIG. 17 is a flow diagram illustrating an exemplary routine for enabling an originating user to determine the status of a task managed by a task management service;

FIG. 18 is a flow diagram illustrating an exemplary routine for updating the status of a task in its managed task list

FIG. 19 is a flow diagram illustrating an exemplary routine implementing a feature monitoring process for monitoring an ongoing content stream for a predetermined feature and, upon detecting the predetermined feature, taking a corresponding action; and

FIG. 20 is a block diagram illustrating exemplary processes executing on a computing device (such as the computing device of FIG. 4) and executing in regard to an ongoing content stream.

### DETAILED DESCRIPTION

For purposes of clarity, the term “exemplary,” as used in this document, should be interpreted as serving as an illustration or example of something, and it should not be interpreted as an ideal and/or a leading illustration of that thing.

For purposes of clarity and definition, the term “content stream” or “ongoing content stream” should be interpreted as being an ongoing occasion in which audio and/or audio visual content can be sensed and recorded. Examples of an ongoing content stream include, by way of illustration and not limitation: a conversation; a lecture; a monologue; a presentation of a recorded occasion; and the like. In addition to detecting a content stream via audio and/or audio/visual sensors or components, according to various embodiments the ongoing content stream may correspond to a digitized content stream which is being receives, as a digital stream, by the user's computing device.

The term “passive recording” refers to an ongoing recording of a content stream. Typically, the content stream corresponds to ongoing, current audio or audio/visual conditions as may be detected by condition sensing device such as, by way of illustration, a microphone. For purposed of simplicity of this disclosure, the description will generally be made in regard to passively recording audio content. However, in various embodiments, the ongoing recording may also include both visual content with the audio content, as may be detected by an audio/video capture device (or devices) such as, by way of illustration, a video camera with a microphone, or by both a video camera and a microphone. The ongoing recording is “passive” in that a recording of the content stream is only temporarily made; any passively recorded content is overwritten with more recent content of the content stream after a predetermined amount of time. In this regard, the purpose of the passive recording is not to generate an audio or audio/visual recording of the content stream for the user, but to temporarily store the most recently recorded content in the event that, upon direction by a person, a transcription to text of the most recently recorded content may be made and stored as a note for the user.

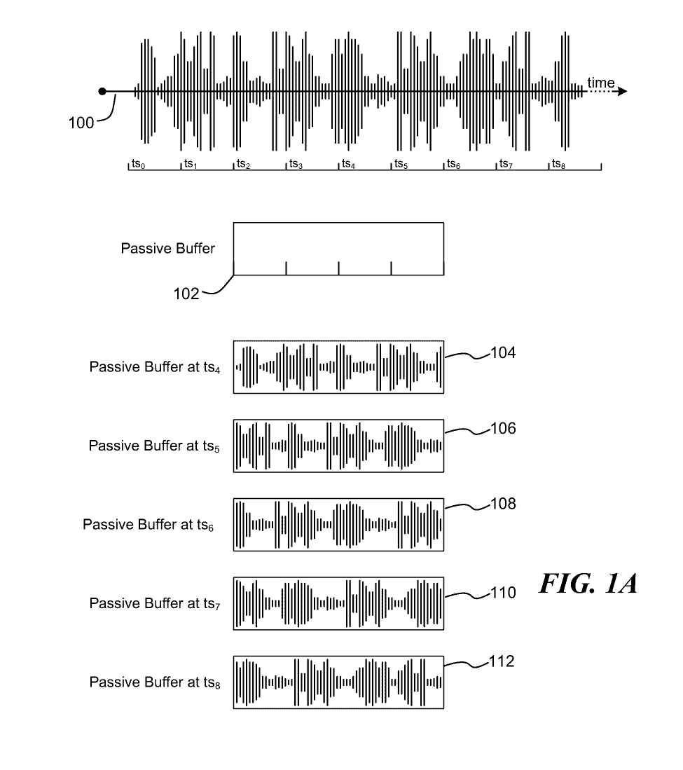

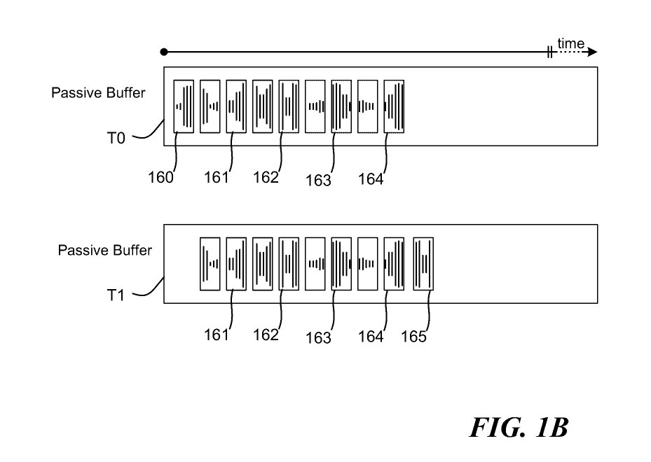

In passively recording the current conditions, e.g., the audio and/or audio/visual conditions, the recently recorded content is placed in a “passive recording buffer.” In operation, the passive recording buffer is a memory buffer in a host computing device configured to hold a limited, predetermined amount of recently recorded content. For example, in operation the passive recording buffer may be configured to store a recording of the most recent minute of the ongoing audio (or audio/visual) conditions as captured by the recording components of the host computing device. To further illustrate aspects of the disclosed subject matter, particularly in regard to passive recording and the passive recording buffer, reference is made to FIG. 1.

FIG. 1 illustrate an exemplary audio stream 102 (i.e., ongoing audio conditions) with regard to a time line 100, and further illustrates various the ongoing passive recording of the audio stream into an exemplary passive recording buffer. According to various embodiments of the disclosed subject matter and shown in FIG. 1, the time (as indicated by time line 100) corresponding to the ongoing audio stream 102 may be broken up according to time segments, as illustrated by time segments ts₀-ts₈. While the time segments may be determined according to implementation details, in one non-limiting example the time segment corresponds to 15 seconds. Correspondingly, the passive recording buffer, such as passive recording buffer 102, may configured such that it can store a predetermined amount of recently recorded content, where the predetermined amount corresponds to a multiple of the amount of recently recorded content that is recorded during a single time segment. As illustratively shown in FIG. 1, the passive recording buffer 102 is configured to hold an amount of the most recently recorded content corresponding to 4 time segments though, as indicted about, this number may be determined according to implementation details and/or according to user preferences.

Conceptually, and by way of illustration and example, with the passive recording buffer 102 configure to temporarily store recently recorded content corresponding to 4 time segments, the passive recording buffer 102 at the beginning of time segment ts₄ will include the recently recorded content from time segments ts₀-ts₃, as illustrated by passive recording buffer 104. Similarly, the passive recording buffer 102, at the start of time period ts₅, will include the recently recorded content from time segments ts₁-ts₄, and so forth as illustrated in passive recording buffers 106-112.

In regard to implementation details, when the recently recorded content is managed according to time segments of content, as described above, the passive recording buffer can implemented as a circular queue in which the oldest time segment of recorded content is overwritten as a new time segment begins. Of course, when the passive recording buffer 102 is implemented as a collection of segments of content (corresponding to time segments), the point at which a user provides an instruction to transcribe the contents of the passive recording buffer will not always coincide with a time segment. Accordingly, an implementation detail, or a user configuration detail, can be made such that recently recorded content of at least a predetermined amount of time is always captured. In this embodiment, if the user (or implementer) wishes to record at least 4 time segments of content, the passive recording buffer may be configured to hold 5 time segments worth of recently recorded content.

While the discussion above in regard to FIG. 1A is made in regard to capturing recently recording content along time segments, it should be appreciated that this is one manner in which the content may be passively recorded. Those skilled in the art will appreciate that there are other implementation methods in this an audio or audio/visual stream may be passively recorded. Indeed, in an alternative embodiment as shown in FIG. 1B, the passive recording buffer is configured to a size sufficient to contain a predetermined maximum amount of passively recorded content (as recorded in various frames) according to time. For example, if the maximum amount (in time) of passively recorded content is 2 minutes, then the passive recording buffer is configured to retain a sufficient number of frames, such as frames 160-164, which collectively correspond to 2 minutes. Thus, as new frames are received (in the on-going passive recording), older frames whose content falls outside of the preceding amount of time for passive recording will be discarded. In reference to passive buffer T0, assuming that the preceding amount of time to passively record is captured in 9 frames (as shown in passive buffer T0), when a new frame 165 is received, it is stored in the passive buffer and the oldest frame 160 is discarded, as shown in passive buffer T1.

While the passive recording buffer may be configured to hold a predetermined maximum amount of recorded content, independent of the maximum amount that a passive recording buffer can contain and according to various embodiments of the disclosed subject matter, a computer user may configure the amount of recent captured content to be transcribed and placed as a note in a note file—of course, constrained by the maximum amount of content (in regard to time) that the passive recording buffer can contain. For example, while the maximum amount (according to time) of passively recorded content that passive recording buffer may contain may be 2 minutes, in various embodiments the user is permitted to configure the length (in time) of passive recorded content to be converted to a note, such as the prior 60 seconds of content, the prior 2 minutes, etc. In this regard, the user configuration as to the length of the audio or audio/visual content stream to be transcribed and stored as a note in a note file (upon user instruction), is independent of the passive recording buffer size (except for the upper limit of content that can be stored in the buffer.) Further, while the example above suggests that the passive recording buffer may contain up to 2 minutes of content, this is merely illustrative and should not be construed as limiting upon the disclosed subject matter. Indeed, in various alternative, non-limiting embodiments, the passive recording buffer may be configured to hold up to any one of 5 minutes of recorded content, 3 minutes of recorded content, 90 seconds of recorded content, etc. Further, the size of the passive recording buffer may be dynamically determined, adjusted as needed according to user configuration as to the length of audio content to be converted to a note in a note file.

Rather than converting the frames (160-165) into an audio stream at the time that the frames are received and stored in the passive buffer, the frames are simply stored in the passive buffer according to their sequence in time. By not processing the frames as they are received but, instead, processing the frames into an audio stream suitable for transcription (as will be described below), significant processing resources may be conserved. However, upon receiving an indication that the content in the passive buffer is to be transcribed into a note, the frames are merged together into an audio (or audio/visual) stream that may be processed by a transcription component or service.

As shown with regard to FIGS. 1A and 1B, there may be any number of implementations of a passive buffer, and the disclosed subject matter should be viewed as being equally applicable to these implementations. Indeed, irrespective of the manner in which a passive buffer is implemented, what is important is that a predetermined period of preceding content is retained and available for transcription at the direction of the person using the system.

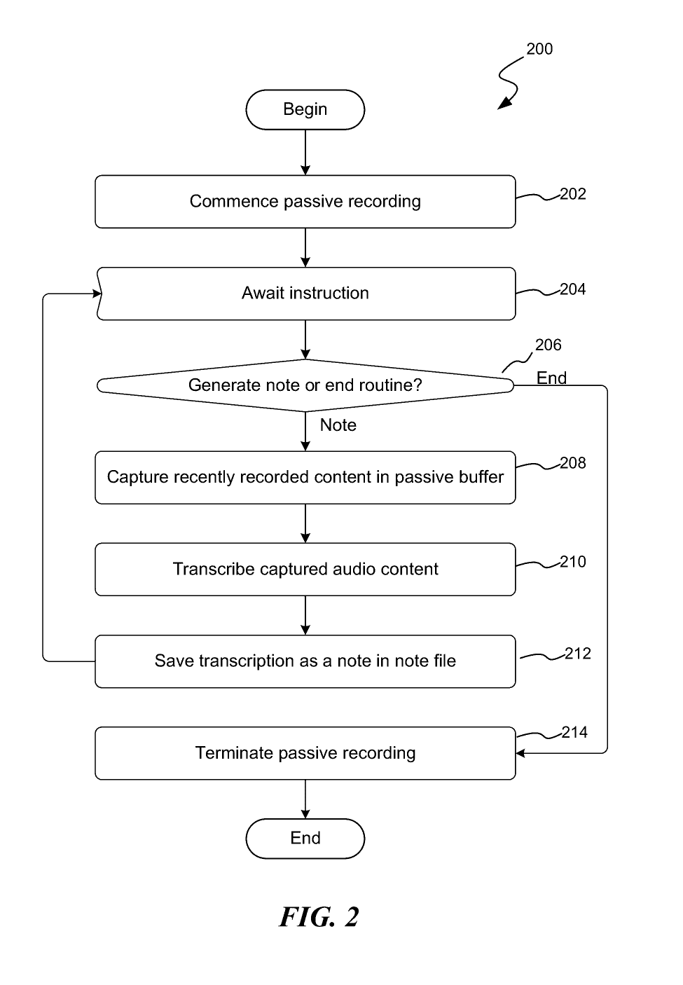

As briefly discussed above, with an ongoing audio stream (or audio/visual stream) being passively recorded, a person (i.e., user of the disclosed subject matter on a computing device) can cause that the most recently recorded content of the ongoing stream be transcribed to text and the transcription recorded in a notes file. FIG. 2 is a flow diagram illustrating an exemplary routine 200 for generating notes, i.e., a textual transcription of the recently recorded content, of the most recently portion of the ongoing audio stream. Beginning at block 202, a passive recording process of the ongoing audio stream is commenced. As should be understood, this passive recording is an ongoing process and continues recording the ongoing audio (or audio/visual) stream (i.e., the content stream) until specifically terminated at the direction of the user, irrespective of other steps/activities that are taken with regard to routine 200. With regard to the format of the recorded content by the passive recording process, it should be appreciated that any suitable format may be used including, by way of illustration and not limitation, MP3 (MPEG-2 audio layer III), AVI (Audio Video Interleave), AAC (Advanced Audio Coding), WMA (Windows Media Audio), WAV (Waveform Audio File Format), and the like. Typically though not exclusively, the format of the recently recorded content is a function of the codec (coder/decoder) that is used to convert the audio content to a file format.

At block 204, with the passive recording of the content stream ongoing, the routine 200 awaits a user instruction. After receiving a user instruction, at decision block 206 a determination is made as to whether the user instruction is in regard to generating notes (from the recorded content in the passive recording buffer 102) or in regard to terminating the routine 200. If the instruction is in regard to generating a note, at block 208 the recently recorded content in the passive recording buffer is captured. In implementation, typically capturing the recently recorded content in the passive recording buffer comprises copying the recently recorded content from the passive recording buffer into another temporary buffer. Also, to the extent that the content in the passive recording buffer is maintained as frames, the frames are merged into an audio stream (or audio/visual stream) into the temporary buffer. This copying is done such that the recently recorded content can be transcribed without impacting the passive recording of the ongoing audio stream such that information/content of the ongoing content stream is continuously recorded.

At block 210, after capturing the recently recorded content in the passive recording buffer, the captured recorded content is transcribed to text. According to aspects of the disclosed subject matter, the captured recorded content may be transcribed by executable transcription components (comprising hardware and/or software components) on the user's computing device (i.e., the same device implementing routine 200). Alternatively, a transcription component may transmit the captured recorded content to an online transcription service and, in return, receive a textual transcription of the captured recorded content. As additional alternatives, the captured recorded content may be temporarily stored for future transcription, e.g., storing the captured recorded content for subsequent uploading to a computing device with sufficient capability to transcribe the content, or storing the captured recorded content until a network communication can be established to obtain a transcription from an online transcription service.

At block 212, the transcription is saved as a note in a note file. In addition to the text transcription of the captured recorded content, additional information may be stored with the note in the note file. Information such as the date and time of the captured recorded content may be stored with or as part of the note in the note file. A relative time (relative to the start of routine 200) may be stored with or as part of the note in the note file. Contextual information, such as meeting information, GPS location data, user information, and the like can be stored with or as part of the note in the note file. After generating the note and storing it in the note file, the routine 200 returns to block 204 to await additional instructions.

At some point, at decision block 206, the user instruction/action may be in regard to terminating the routine 200. Correspondingly, the routine 200 proceeds to block 214 where the passive recording of the ongoing audio (or audio/visual) stream is terminated, and the routine 200 terminates.

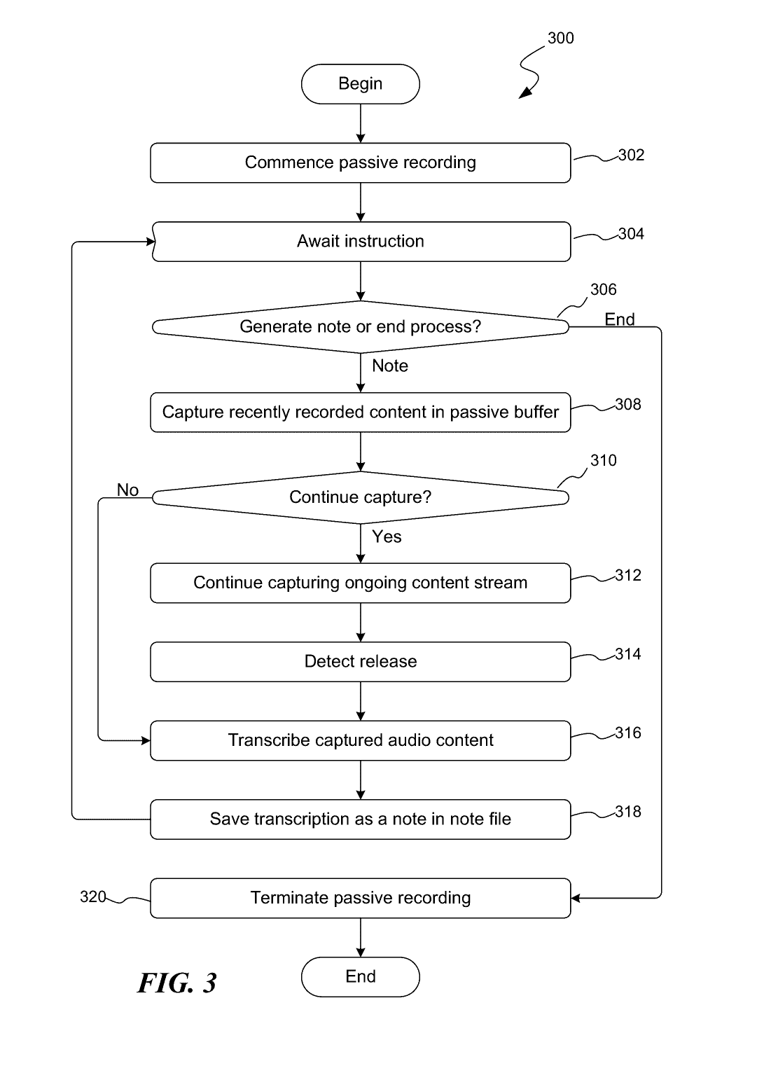

Often, an interesting portion of an ongoing conversation/stream may be detected and the user will wish to not only capture notes regarding the most recent time period, but continue to capture the content in an ongoing manner. The disclosed subject matter may be suitably and advantageously implemented to continue capturing the content (for transcription to a text-based note) as described in regard to FIG. 3. FIG. 3 is a flow diagram illustrating an exemplary routine 300 for generating notes of the most recently portion of the ongoing content stream, and for continued capture until indicated by a user. As will be seen, many aspects of routine 200 and routine 300 are the same.

Beginning at block 302, a passive recording process of the ongoing audio stream is commenced. As indicated above in regard to routine 200, this passive recording process is an ongoing process and continues recording the ongoing content stream until specifically terminated, irrespective of other steps/activities that are taken with regard to routine 300. With regard to the format of the recently recorded content, it should be appreciated that any suitable format may be used including, by way of illustration and not limitation, MP3 (MPEG-2 audio layer III), AVI (Audio Video Interleave), AAC (Advanced Audio Coding), WMA (Windows Media Audio), WAV (Waveform Audio File Format), and the like.

At block 304, with the passive recording ongoing, the routine 300 awaits a user instruction. After receiving a user instruction, at decision block 306 a determination is made as to whether the user instruction is in regard to generating a note (from the recorded content in the passive recording buffer 102) or in regard to ending the routine 300. If the user instruction is in regard to generating a note, at block 308 the recently recorded content in the passive recording buffer is captured. In addition to capturing the recorded content from the passive recording buffer, at decision block 310 a determination is made in regard to whether the user has indicated that the routine 300 should continue capturing the ongoing audio stream for transcription as an expanded note. If the determination is made that the user has not indicated that the routine 300 should continue capturing the ongoing audio stream, the routine proceeds to block 316 as described below. However, if the user has indicated that the routine 300 should continue capturing the ongoing audio stream as part of an expanded note, the routine proceeds to block 312.

At block 312, without interrupting the passive recording process, the ongoing recording of the ongoing content stream to the passive recording buffer is continually captured as part of expanded captured recorded content, where the expanded captured recorded content is, thus, greater than the amount of recorded content that can be stored in the passive recording buffer. At block 314, this continued capture of the content stream continues until an indication from the user is received to release or terminate the continued capture. At block 316, after capturing the recently recorded content in the passive recording buffer and any additional content as indicated by the user, the captured recorded content is transcribed to text. As mentioned above in regard to routine 200 of FIG. 2, the captured recorded content may be transcribed by executable transcription components (comprising hardware and/or software components) on the user's computing device. Alternatively, a transcription component may transmit the captured recorded content to an online transcription service and, in return, receive a textual transcription of the captured recorded content. As additional alternatives, the captured recorded content may be temporarily stored for future transcription, e.g., storing the captured recorded content for subsequent uploading to a computing device with sufficient capability to transcribe the content, or storing the captured recorded content until a network communication can be established to obtain a transcription from an online transcription service.

At block 318, the transcription is saved as a note in a note file, i.e., a data file comprising at least one or more text notes. In addition to the text transcription of the captured recorded content, additional information may be stored with the note in the note file. Information such as the date and time of the captured recorded content may be stored with or as part of the note in the note file. A relative time (relative to the start of routine 200) may be stored with or as part of the note in the note file. Contextual information, such as meeting information, GPS location data, user information, and the like can be stored with or as part of the note in the note file. After generating the note and storing it in the note file, the routine 300 returns to block 304 to await additional instructions.

As mentioned above, at decision block 306, the user instruction/action may be in regard to terminating the routine 300. In this condition, the routine 300 proceeds to block 320 where the passive recording of the ongoing audio (or audio/visual) stream is terminated, and thereafter the routine 300 terminates.

Regarding routines 200 and 300 described above, as well as routines 1000-1100 and 1400-1900 described below as well as other processes describe herein, while these routines/processes are expressed in regard to discrete steps, these steps should be viewed as being logical in nature and may or may not correspond to any actual and/or discrete steps of a particular implementation. Also, the order in which these steps are presented in the various routines and processes, unless otherwise indicated, should not be construed as the only order in which the steps may be carried out. In some instances, some of these steps may be omitted. Those skilled in the art will recognize that the logical presentation of steps is sufficiently instructive to carry out aspects of the claimed subject matter irrespective of any particular language in which the logical instructions/steps are embodied.

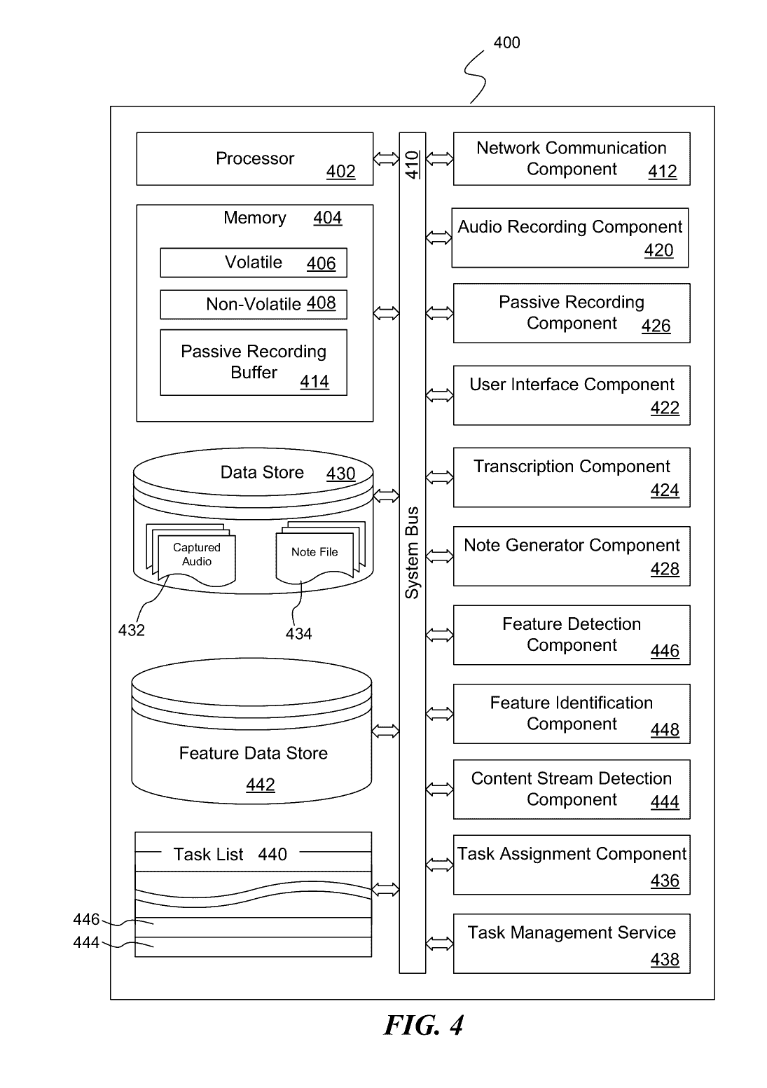

Of course, while these routines include various novel features of the disclosed subject matter, other steps (not listed) may also be carried out in the execution of the subject matter set forth in these routines. Those skilled in the art will appreciate that the logical steps of these routines may be combined together or be comprised of multiple steps. Steps of the above-described routines may be carried out in parallel or in series. Often, but not exclusively, the functionality of the various routines is embodied in software (e.g., applications, system services, libraries, and the like) that is executed on one or more processors of computing devices, such as the computing device described in regard FIG. 4 below. Additionally, in various embodiments all or some of the various routines may also be embodied in executable hardware modules including, but not limited to, system on chips, codecs, specially designed processors and or logic circuits, and the like on a computer system.

These routines/processes are typically embodied within executable code modules comprising routines, functions, looping structures, selectors such as if-then and if-then-else statements, assignments, arithmetic computations, and the like. However, the exact implementation in executable statement of each of the routines is based on various implementation configurations and decisions, including programming languages, compilers, target processors, operating environments, and the linking or binding operation. Those skilled in the art will readily appreciate that the logical steps identified in these routines may be implemented in any number of ways and, thus, the logical descriptions set forth above are sufficiently enabling to achieve similar results.

While many novel aspects of the disclosed subject matter are expressed in routines embodied within applications (also referred to as computer programs), apps (small, generally single or narrow purposed, applications), and/or methods, these aspects may also be embodied as computer-executable instructions stored by computer-readable media, also referred to as computer-readable storage media, which are articles of manufacture. As those skilled in the art will recognize, computer-readable media can host, store and/or reproduce computer-executable instructions and data for later retrieval and/or execution. When the computer-executable instructions that are hosted or stored on the computer-readable storage devices are executed, the execution thereof causes, configures and/or adapts the executing computing device to carry out various steps, methods and/or functionality, including those steps, methods, and routines described above in regard to the various illustrated routines. Examples of computer-readable media include, but are not limited to: optical storage media such as Blu-ray discs, digital video discs (DVDs), compact discs (CDs), optical disc cartridges, and the like; magnetic storage media including hard disk drives, floppy disks, magnetic tape, and the like; memory storage devices such as random access memory (RAM), read-only memory (ROM), memory cards, thumb drives, and the like; cloud storage (i.e., an online storage service); and the like. While computer-readable media may deliver the computer-executable instructions (and data) to a computing device for execution via various transmission means and mediums including carrier waves and/or propagated signals, for purposes of this disclosure computer readable media expressly excludes carrier waves and/or propagated signals.

Advantageously, many of the benefits of the disclosed subject matter can be conducted on computing devices with limited computing capacity and/or storage capabilities. Further still, many of the benefits of the disclosed subject matter can be conducted on computing devices of limited computing capacity, storage capabilities as well as network connectivity. Indeed, suitable computing devices suitable for implementing the disclosed subject matter include, by way of illustration and not limitation: mobile phones; tablet computers; “phablet” computing devices (the hybrid mobile phone/tablet devices); personal digital assistants; laptop computers; desktop computers; and the like.

Regarding the various computing devices upon which aspects of the disclosed subject matter may be implemented, FIG. 4 is a block diagram illustrating exemplary components of a suitably configured computing device 400 for implementing aspects of the disclosed subject matter. The exemplary computing device 400 includes one or more processors (or processing units), such as processor 402, and a memory 404. The processor 402 and memory 404, as well as other components, are interconnected by way of a system bus 410. The memory 404 typically (but not always) comprises both volatile memory 406 and non-volatile memory 408. Volatile memory 406 retains or stores information so long as the memory is supplied with power. In contrast, non-volatile memory 408 is capable of storing (or persisting) information even when a power supply is not available. Generally speaking, RAM and CPU cache memory are examples of volatile memory 406 whereas ROM, solid-state memory devices, memory storage devices, and/or memory cards are examples of non-volatile memory 408. Also illustrated as part of the memory 404 is a passive recording buffer 414. While shown as being separate from both volatile memory 406 and non-volatile memory 408, this distinction is for illustration purposes in identifying that the memory 404 includes (either as volatile memory or non-volatile memory) the passive recording buffer 414.

Further still, the illustrated computing device 400 includes a network communication component 412 for interconnecting this computing device with other devices over a computer network, optionally including an online transcription service as discussed above. The network communication component 412, sometimes referred to as a network interface card or NIC, communicates over a network using one or more communication protocols via a physical/tangible (e.g., wired, optical, etc.) connection, a wireless connection, or both. As will be readily appreciated by those skilled in the art, a network communication component, such as network communication component 412, is typically comprised of hardware and/or firmware components (and may also include or comprise executable software components) that transmit and receive digital and/or analog signals over a transmission medium (i.e., the network.)

The processor 402 executes instructions retrieved from the memory 404 (and/or from computer-readable media) in carrying out various functions, particularly in regard to responding to passively recording an ongoing audio or audio/visual stream and generating notes from the passive recordings, as discussed and described above. The processor 401 may be comprised of any of a number of available processors such as single-processor, multi-processor, single-core units, and multi-core units.

The exemplary computing device 400 further includes an audio recording component 420. Alternatively, not shown, the exemplary computing device 400 may be configured to include an audio/visual recording component, or both an audio recording component and a visual recording component, as discussed above. The audio recording component 420 is typically comprised of an audio sensing device, such as a microphone, as well as executable hardware and software, such as a hardware and/or software codec, for converting the sensed audio content into recently recorded content in the passive recording buffer 414. The passive recording component 426 utilizes the audio recording component 420 to capture audio content to the passive recording bugger, as described above in regard to routines 200 and 300. A note generator component 428 operates at the direction of the computing device user (typically through one or more user interface controls in the user interface component 422) to passively capture content of an ongoing audio (or audio/visual) stream, and to further generate one or more notes from the recently recorded content in the passive recording buffer 414, as described above. As indicated above, the note generator component 428 may take advantage of an optional transcription component 424 of the computing device 400 to transcribe the captured recorded content from the passive recording buffer 414 into a textual representation for saving in a note file 434 (of a plurality of note files) that is stored in a data store 430. Alternatively, the note generator component 428 may transmit the captured recorded content of the passive recording buffer 414 to an online transcription service over a network via the network communication component 412, or upload the captured audio content 432, temporarily stored in the data store 430, to a more capable computing device when connectivity is available.

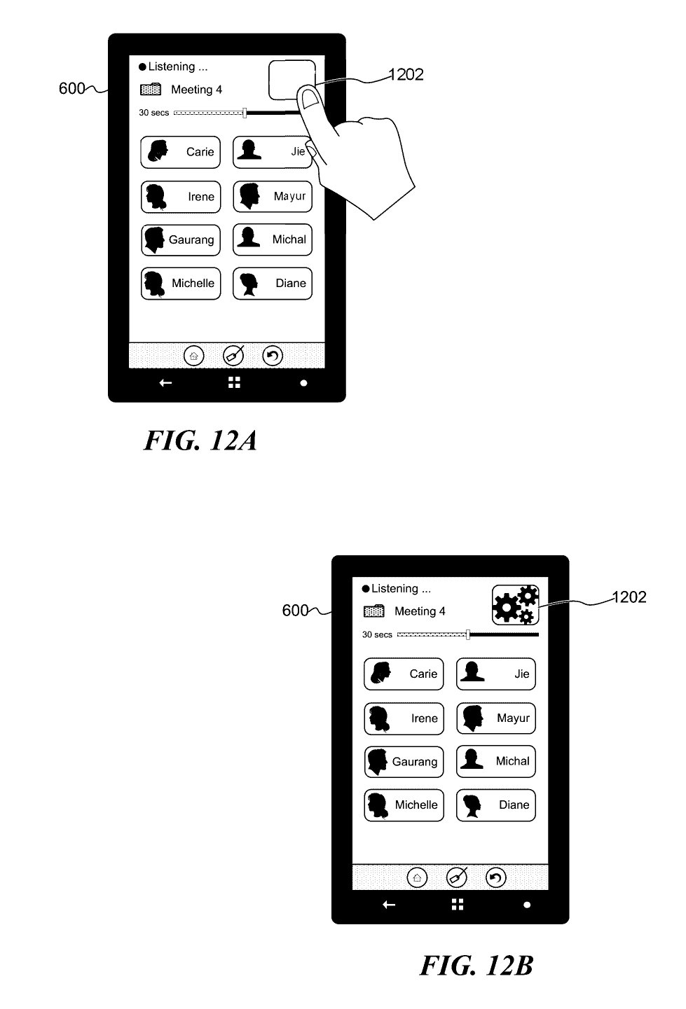

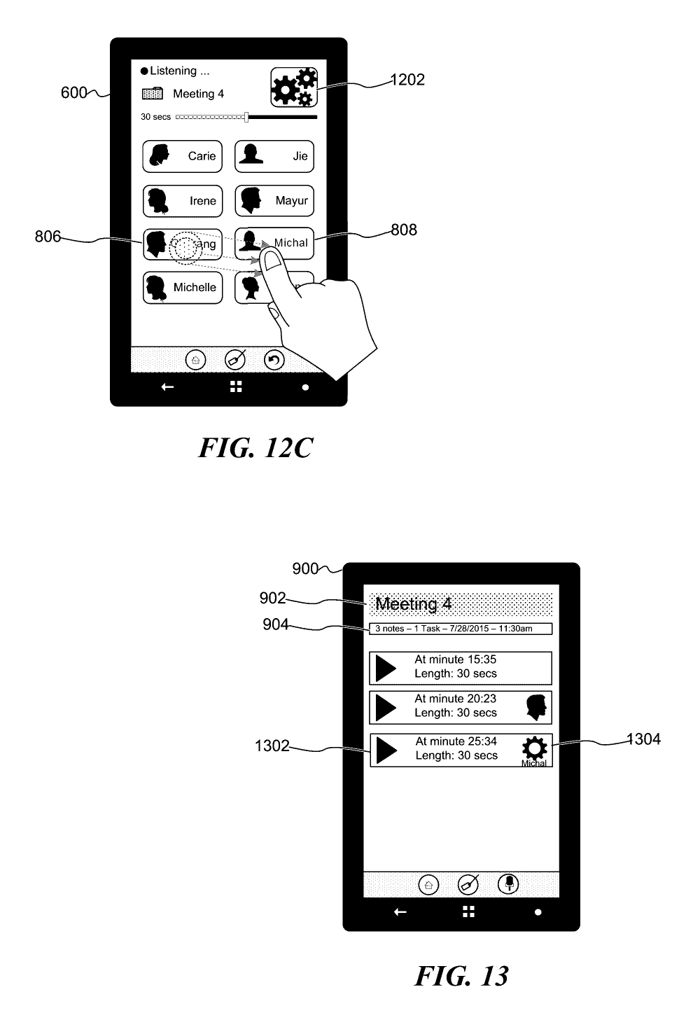

A task assignment component 436 is configured to associate a task assignment with a generated note. Assigning a task to a generated note is described in greater detail below in regard to FIGS. 12-18. Also included is a task management service 438. In operation, the task management service 438 receives a request from the task assignment component 436, creates a task entry, such as task entry 446 or 444 in a task list 440, and notifies a target user/person to whom the task is assigned. The task management service 438 further maintains the status of the task (corresponding to the generated note) and updates the status in response to a message from the target user.

With regard to the task management service 438, while the task management service is illustrated as residing upon the computing device for capturing a note from an ongoing content stream, this is illustrative of one embodiment and is not limiting upon the disclosed subject matter. In an alternative embodiment, the task management service 438 operates as a service on a computing device external to a user's computing device upon which the passive listening and capturing is conducted. By way of illustration and not limitation, the task management service 438 may be implemented as a managed service on one or more computing devices configured for providing task assignment services.

Regarding the data store 430, while the data store may comprise a hard drive and/or a solid state drive separately accessible from the memory 404 typically used on the computing device 400, as illustrated, in fact this distinction may be simply a logical distinction. In various embodiments, the data store is a part of the non-volatile memory 408 of the computing device 400. Additionally, while the data store 430 is indicated as being a part of the computing device 400, in an alternative embodiment the data store may be implemented as a cloud-based storage service accessible to the computing device over a network (via the network communication component 412).

The exemplary computing device 400 is further illustrated as including a feature detection component 446. In operation, the feature detection component 446 executes as a process (a feature detection process described below) in monitoring the ongoing content stream for various predetermined features stored in a feature data store 442 which, when detected in the ongoing content stream by a content stream detection component 444, causes the feature detection component to execute one or more actions/activities associated with the detected feature in the feature data store. As will be described in greater detail below, these actions may include automatic capture/generation of a note from the content in the passive recording buffer, tagging a note with a category or assigning a note as a task to another person, identifying the speaker of the note, and the like.

Still further, the exemplary computing device includes a feature identification component 448. In operation, the feature identification component 448 executes as an on-going process on the computing device 400 in conjunction with the process of passively recording the ongoing content stream in a passive recording buffer. In contrast to the feature detection component 446, the process implemented by the feature identification component 448 is a machine learning component that analyzes the behavior of the user with regard to the user capturing notes and taking corresponding actions from the passive recording buffer and makes suggestions, or even take automatic actions, for the user in regard to the learned information. As those skilled in the art will appreciate, machine learning is typically conducted in regard to a model (i.e., modeling the behavior of the user) and generally includes at least three phases: model creation, model validation, and model utilization, though these phases are not mutually exclusive. Indeed, model creation, validation and utilization are on-going processes of the machine learning process as conducted by the feature identification component 448.

Generally speaking, for the feature identification component 448, the model creation phase involves identifying information that is viewed as being important to the user. In regard to the feature identification component 448, this component monitors the ongoing content streams to detect “features” in a stream that appears to cause the user of the computing device to capture a note from the passive recording buffer, as well as take actions. In regard to a feature, while a feature may correspond to simply the detection of a particular word or phrase in the ongoing content stream, features may be based on numerous and varied conditions that are substantially more complex than mere word detection. Indeed, a feature may comprise conditions based on logic and operators combined in various manners with detected patterns of speech, speed of speech, tone of speech, volume, the particular speaker, the relationship of one word or phrase with regard to another, timing of words, parts of speech used, and the like. By way of illustration and not limitation, a feature may comprise the detection of conditions such as: phrase P occurring within two words after word W by speaker S. Another non-limiting example may comprise the conditions of: word W used as part of speech A within phrase P.

As those skilled in the art will appreciate, these features are derived from statistical analysis and machine learning techniques on large quantities of data collected over time, based on patterns such as tone and speed of speech as well as observed behavior (with regard to capturing notes, annotating notes with categories, assigning notes to persons, etc., to create the machine learning model. Based on the observations of this monitoring, the feature identification component 448 creates a model (i.e., a set of rules or heuristics) for capturing notes and/or conducting activities with regard to an ongoing content stream.

During the second phase of machine learning, the model created during the model creation phase is validated for accuracy. During this phase, the feature identification component 448 monitors the user's behavior with regard to actions taken during the ongoing content stream and compares those actions against predicted actions made by the model. Through continued tracking and comparison of this information and over a period of time, the feature identification component 448 can determine whether the model accurately predicts which parts of the content stream are likely to be captured as notes by the user using various actions. This validation is typically expressed in terms of accuracy: i.e., what percentage of the time does the model predict the actions of the user. Information regarding the success or failure of the predictions by the model is fed back to the model creation phase to improve the model and, thereby, improve the accuracy of the model.

The third phase of machine learning is based on a model that is validated to a predetermined threshold degree of accuracy. For example and by way of illustration, a model that is determined to have at least a 50% accuracy rate may be suitable for the utilization phase. According to aspects of the disclosed subject matter, during this third, utilization phase, the feature identification component 448 listens to the ongoing content stream, tracking and identifying those parts of the stream where the model suggests that the user would typically take action. Indeed, upon encountering those features in which the model suggests that the user would take action/activity, the contents of the passive recording buffer and/or various activities and actions that might be associated with a note from that content, are temporarily stored. The temporarily stored items are later presented to the user at the end of a meeting as suggestions to the user. Of course, information based on the confirmation or rejection of the various suggestions by the user is returned back to the previous two phases (validation and creation) to as data to be used to refine the model in order to increase the model's accuracy for the user. Indeed, the user may further confirm various suggestions as actions to be taken such that the action is automatically taken without any additional user input or confirmation.

Regarding the various components of the exemplary computing device 400, those skilled in the art will appreciate that these components may be implemented as executable software modules stored in the memory of the computing device, as hardware modules and/or components (including SoCs—system on a chip), or a combination of the two. Indeed, components such as the passive recording component 426, the note generator component 428, the transcription component 424, the task assignment component 436 , and the task management service 438, as well as others, may be implemented according to various executable embodiments including executable software modules that carry out one or more logical elements of the processes described in this document, or as hardware components that include executable logic to carry out the one or more logical elements of the processes described in this document. Examples of these executable hardware components include, by way of illustration and not limitation, ROM (read-only memory) devices, programmable logic array (PLA) devices, PROM (programmable read-only memory) devices, EPROM (erasable PROM) devices, logic circuitry and devices, and the like, each of which may be encoded with instructions and/or logic which, in execution, carry out the functions described herein.

Moreover, in certain embodiments each of the various components may be implemented as an independent, cooperative process or device, operating in conjunction with or on one or more computer systems and or computing devices. It should be further appreciated, of course, that the various components described above should be viewed as logical components for carrying out the various described functions. As those skilled in the art will readily appreciate, logical components and/or subsystems may or may not correspond directly, in a one-to-one manner, to actual, discrete components. In an actual embodiment, the various components of each computing device may be combined together or distributed across multiple actual components and/or implemented as cooperative processes on a computer network.

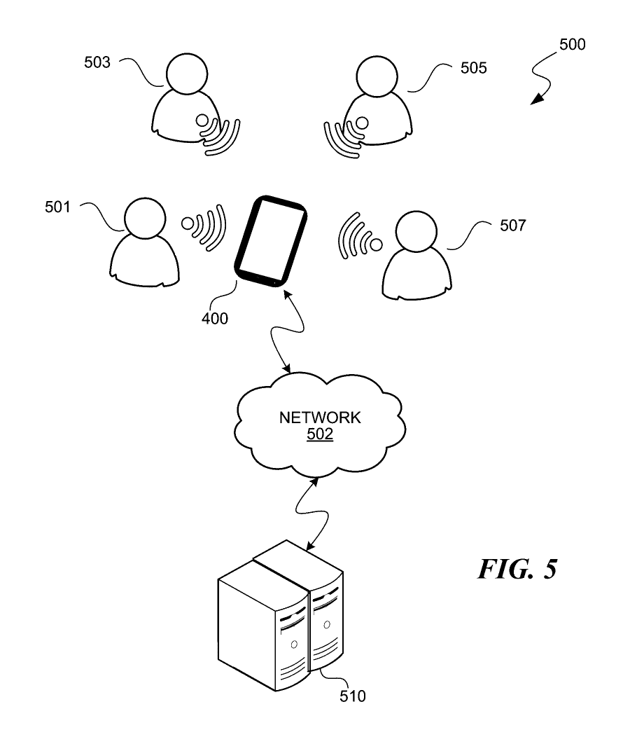

FIG. 5 is a pictorial diagram illustrating an exemplary environment 500 suitable for implementing aspects of the disclosed subject matter. As shown in FIG. 5, a computing device 400 (in this example the computing device being a mobile phone of user/person 501) may be configured to passively record an ongoing conversation among various persons as described above, including persons 501, 503, 505 and 507. Upon an indication by the user/person 501, the computing device 400 captures the contents of the passive recording buffer 414, obtains a transcription of the recently recorded content captured from the passive recording buffer, and stores the textual transcription as a note in a note file in a data store. The computing device 400 is connected to a network 502 over which the computing device may obtain a transcription of captured audio content (or audio/visual content) from a transcription service 510, and/or store the transcribed note in an online and/or cloud-based data store (not shown).

In addition to capturing or generating a note of an ongoing content stream, quite often a person may wish to identify the current speaker of the captured note, i.e., associate or annotate the name or identity of the speaker with the note. For example, in a business meeting, it is often important to capture who proposed a particular idea or raised a particularly salient set of issues. Similarly, it may be important to identify who has suggested taking various actions or activities. Alternatively, in a family meeting, it might be very useful in associating a particular discussion with the person speaking. Indeed, in these circumstances and others, it would be advantageous to be able to annotate a captured note with the identity of a person (either as one speaking or to which a particular conversation pertains) for future reference.

Still further, while generating a note from an ongoing conversation may capture critical information, locating that a particular note and/or understanding the context of a particular note may be greatly enhanced when the person is able to associate the identity of the speaker (or the subject of the conversation) with the note, i.e., annotate the captured note with the identity of a person. With reference to the examples above, that person may greatly enhance the efficiency by which he/she can recall the particular context of a note and/or identify one or more notes that pertain to that person by associating the note with the identity of a person (or the identities of multiple persons.

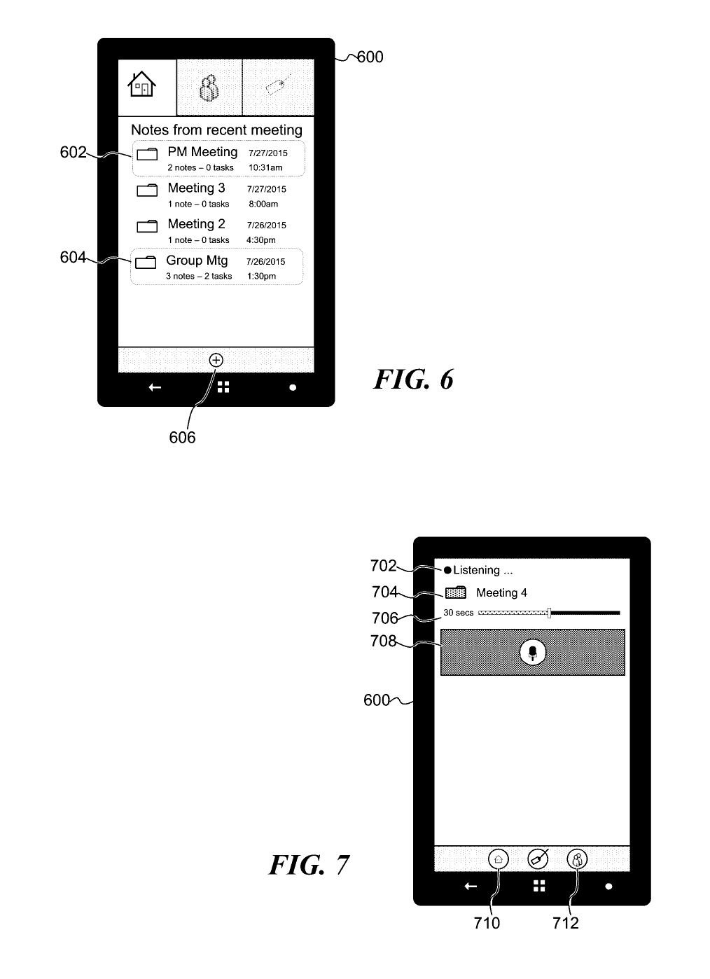

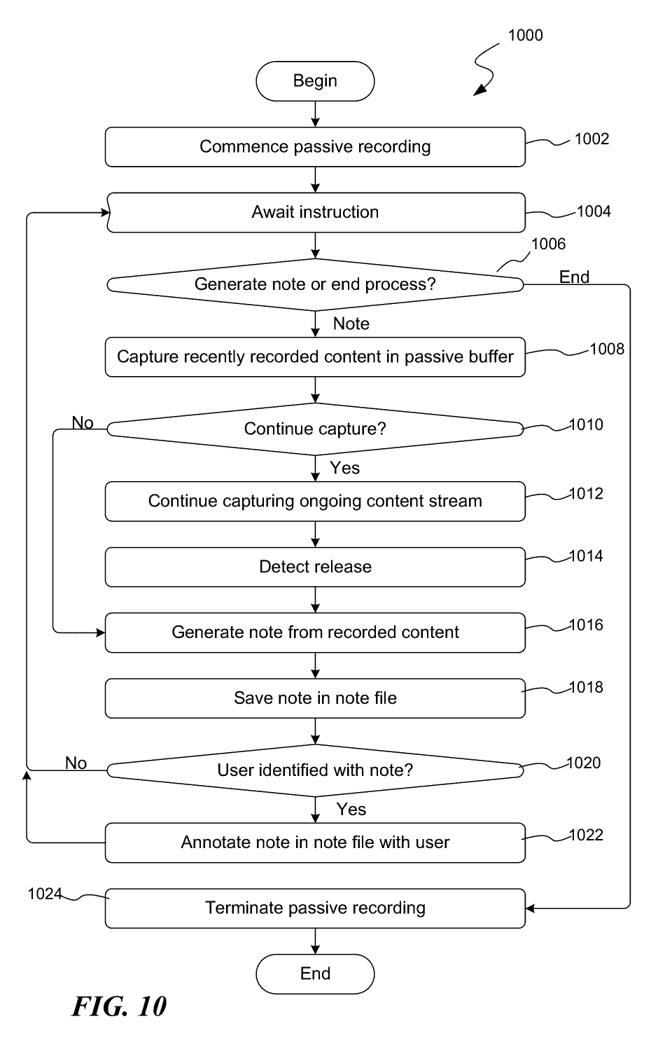

According to aspects of the disclosed subject matter, during an ongoing passive recording of a content stream, a person may provide an indication as to the identity of a person to be associated with a generated note (i.e., a note to be captured from the passive recording buffer as described above). This indication may be made as part of or in addition to providing an indication to capture and generated a particular note of an ongoing conversation or audio stream, as set forth in regard to FIGS. 6-9 and 10. Indeed, FIGS. 6-9 illustrate an exemplary interaction with a computing device executing an application for capturing notes from an on-going audio conversation, and further illustrating the annotation of a captured note with the identity of one or more persons. FIG. 10 illustrates an exemplary routine 1000 for generating notes of the most recently passively recorded content of the ongoing content stream, for continued capture until indicated by a user, and for annotating the captured note with the identity of one or more persons.

With regard to FIGS. 6-9, FIG. 6 illustrates a typical home screen as presented by an app (or application) executing on a computing device 600. The home screen illustrates/includes several meeting entries, such as meeting entries 602 and 604, for which the user of the computing device has caused the app or application to capture notes from an on-going conversation. According to aspects of the disclosed subject matter, meetings are used and viewed as an organizational tool of captured notes, i.e., for providing a type of folder in which captured notes can be grouped together. As can be seen, meeting 602 entitled “PM Meeting,” which occurred on “Jul. 27, 2015” at “10:31 AM,” includes two captured notes. Similarly, meeting 604 entitled “Group Mtg,” occurred on “Jul. 28, 2015” at “1:30 PM” and includes three captured notes.

In addition to listing the “meetings” (which, according to various embodiments, is more generically used as a folder for collecting generated notes of an on-going audio stream), a user may also create a new meeting (or folder corresponding to the meeting) by interacting with the “add meeting” control 606. Thus, if the user is attending an actual meeting and wishes to capture (or may wish to capture) notes from the conversation of the meeting, the user simply interacts with the “add meeting” control 606, which begins the action of passively recording an ongoing content stream and thereby enabling the user to capture notes.

Turning to FIG. 7, FIG. 7 illustrates the exemplary computing device 600 of FIG. 6 after the user has interacted with the “add meeting” control 606. As indicated above, according to one embodiment of the disclosed subject matter, as part of creating a new meeting, the note capturing app/application executing on the computing device 600 begins the process of passively recording the on-going content stream, as indicated by the status indicator 702. In addition to the status indicator 702, a meeting title 704 is also displayed, in this case the title being a default title (“Meeting 4”) for the new meeting. Of course, in various embodiments, the default title of the meeting may be user configurable to something meaningful to the user. Alternatively, the title of a meeting may be obtained from the user's calendar (i.e., a meeting coinciding with the current time). Also shown by the app on the computing device 600 is a duration control 706 by which the user can control the amount/duration (as a function of seconds) of content that is captured in the passive recording buffer, as described above. In the present example, the amount of content, in seconds, that is captured in the passive recording buffer is set at 30 seconds, i.e., at least the prior 30 seconds worth of content is captured in the passive recording buffer and available for generating a note.

Also shown in FIG. 7 is a capture button 708. According to aspects of the disclosed subject matter, by interacting with the capture button 708, the user can cause the underlying app to capture/generate a note from the content captured in the passive recording buffer and store the note, in conjunction with the meeting, in a note file as described above. Indeed, as also described, through continued interaction with the capture button 708, such as continuing to press on the capture button 708, the amount of content that is captured in the currently captured/generated note is extended until the interaction ceases, thereby extending the amount or duration of content that is captured in a note. Also presented on the computing device 600 is a home control 710 that causes the passive recording operation to cease and returns to the home page (as illustrated in FIG. 6), and a user toggle control 712 that switches from “typical” note capturing to annotated note capturing according to user, as described below.

In addition to simply capturing a note from the on-going content stream, a user may wish to associate the identity of the current speaker with a captured note as an annotation to the note. According to aspects of the disclosed subject matter, a user may annotate an already-captured note with the identity of one or more users after the note has been captured/generated. Alternatively, a user may cause that a note be generated in conjunction with the selection of the identity of one or more users, which identity (identities) are to be associated with the generated note. Indeed, by interacting with the user toggle control 712, the user can switch to/from simply capturing notes to a screen for capturing notes to be annotated with the identity of a user (or users).

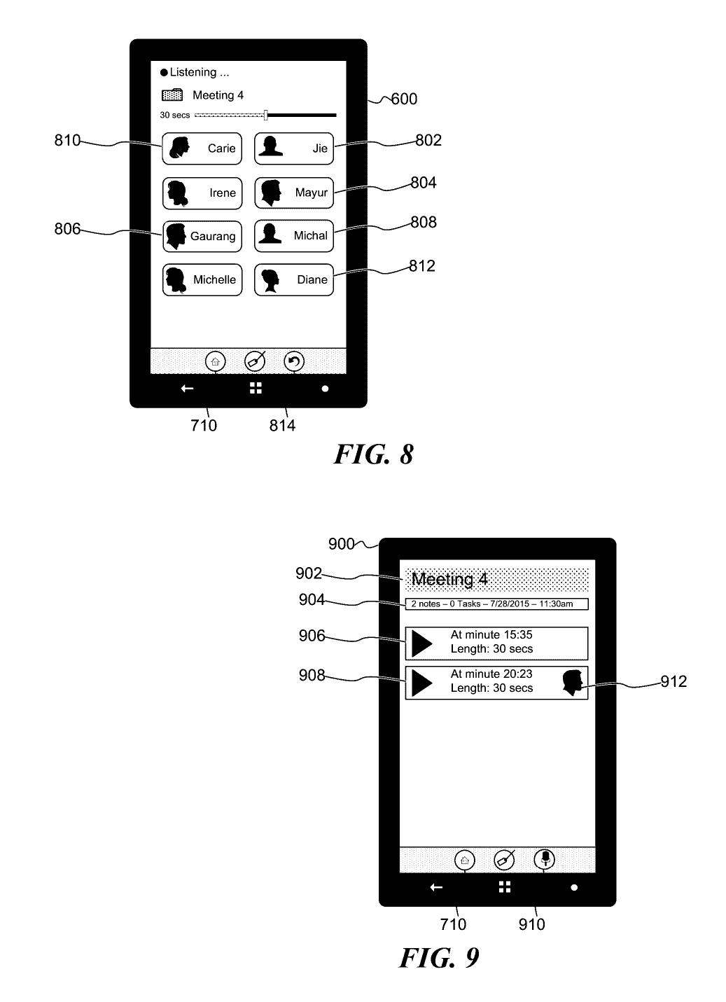

FIG. 8 illustrates the exemplary computing device 600 after the user has switched to the presentation of user-actionable controls, each control associated with the identity of a different person associated with the meeting, and each control configure to cause the generation of a note from the content of the passive recording buffer and to associate the identity of the corresponding user-actionable control with the note as an annotation. As shown in FIG. 8, the computing device 600 now presents a list of user-actionable controls 802-812, each control being associated with a particular person/users of the meeting. Indeed, according to aspects of the disclosed subject matter, by interacting with any one of the user-actionable controls 802-812, a note is generated and stored in the note file and annotated with user identity associated with the user-actionable control, and also associated with the meeting/event corresponding to the ongoing content stream. In other words, the indication to associate the user identity with a generated note is also an indication to generate a note based on the recorded content of the passive recording of the ongoing content stream. Also shown in FIG. 8 are the home control 710 that causes the passive recording to cease and returns to home page (as illustrated in FIG. 6), and a revert toggle control 814 that switches or toggles between “typical” note capturing (as shown in FIG. 7) and the “annotated” note capturing as shown in FIG. 8.

It should be appreciated and according to various embodiments, while a user may generate a note through interaction with a user-actionable control associated with the identity of a person, such as user-actionable control 802, a user may further configure a generated note to be associated with one or more additional persons. In this manner, a generated note may be associated with the identities of multiple persons. Of course, as will be readily appreciated, quite often the conversation for which a particular note generated is applicable to more than one party. While the computing device 600 of FIG. 8 illustrates a manner in which the identity of a single person may be associated with a note, other user interfaces may be presented in which the user is able to associate the identity of one or more users with a generated note, i.e., the user may add, delete and/or modify the users that are associated with any given note.

Assuming that the user has captured both a non-annotated note and annotated note (i.e., a note to which the identity of a user is associated) for the meeting shown in the exemplary FIGS. 6-8, FIG. 9 illustrates the exemplary computing device 600 showing the notes captured and associated with “Meeting 4.” Indeed, as shown in FIG. 9, a title control 902 displays the current name of the meeting (“Meeting 4”), a status control 904 illustrates various status information regarding the notes of the meeting, including that there are two (2) notes captured from the meeting, and further includes note 906 and 908. According to the illustrated embodiment, each note 906 and 908 is presented as a user-actionable control for presenting the corresponding note to the user. As can be seen, the first note 906 is not associated with a person (as indicted by the lack of any person's image on the control), whereas note 908 is associated/annotated with a person as indicted by the presence of the party's image 912. In addition to the note controls 906 and 908, the computing device 600 also includes a user-actionable record icon 910 that returns to recording notes (either of the screens displayed in FIG. 7 or 8) to continue capturing notes for this meeting.

While FIGS. 6-9 illustrate a particular set of user interfaces for interacting with an app executing on a computing device for capturing notes with a user identity annotation, it should be appreciated that this is simply one example of such user interaction and should note be viewed as limiting upon the disclosed subject matter. Those skilled in the art will appreciate that there may be any number of user interfaces that may be suitably used by an app to capture a note of an on-going audio stream from a passive recording buffer and associated or annotate the note with the identity of one or more users.

Turning to FIG. 10, FIG. 10 illustrates an exemplary routine 1000 for generating notes of the most recently portion of the ongoing content stream as located in the passive recording buffer as described above, for continued capture until indicated by a user, and for annotating the captured note with the identity of one or more users/persons. Beginning at block 1002, a passive recording process of the ongoing audio stream is commenced. At block 1004, with the passive recording ongoing, the routine 1000 awaits a user instruction.

After receiving user instruction, at decision block 1006 a determination is made as to whether the user instruction is in regard to generating a note (from the recorded content in the passive recording buffer 102) or in regard to ending the routine 1000. If the user instruction is in regard to generating a note, at block 1008 the recently recorded content in the passive recording buffer is captured. In addition to capturing the recorded content from the passive recording buffer, at decision block 1010 a determination is made in regard to whether the user has indicated that the routine 1000 should continue capturing the ongoing audio stream for transcription as an expanded note. If the determination is made that the user has not indicated that the routine 1000 should continue capturing the ongoing audio stream, the routine proceeds to block 1016 as described below. However, if the user has indicated that the routine 1000 should continue capturing the ongoing audio stream as part of an expanded note, the routine proceeds to block 1012. At block 1012, without interrupting the passive recording process, the ongoing recording of the ongoing content stream to the passive recording buffer is continually captured as part of expanded captured recorded content, where the expanded captured recorded content is, thus, greater than the amount of recorded content that can be stored in the passive recording buffer.

At block 1014, this continued capture of the content stream continues until an indication from the user is received to release or terminate the continued capture. At block 1016, after capturing the recently recorded content in the passive recording buffer and any additional content as indicated by the user, a note is generated from the captured recorded content. According to various embodiments, the note may be generated according to a transcription of the recorded/captured content. Alternatively, a note may be generated as a single audio file from the recorded/captured content. Further still, a note may be stored in a note file in multiple formats, such as an audio file and a transcription.

At block 1018, the generated note is then stored in a note file, i.e., a data file comprising at least one or more text notes. As indicated above, according to various embodiments, the note may be stored in a note file in association with (or as part of) a meeting. At block 1020, a determination is made as to whether the identity of a person is to be associated with the generated note, i.e., whether to annotate the note with the identity of one or more persons. If the note is not to be annotated with the identity of one or more persons, the routine 1000 returns to block 1004 to await additional user instructions. Alternatively, if the generated note is to be annotated with the identity of one or more persons, at block 1022 the note is annotated with the associated person's identity and the routine 1000 returns to block 1004.

As mentioned above, at decision block 1006, the user instruction/action may be in regard to terminating the routine 1000. In this condition, the routine 1000 proceeds to block 1024 where the passive recording of the ongoing audio (or audio/visual) stream is terminated, and thereafter the routine 1000 terminates.

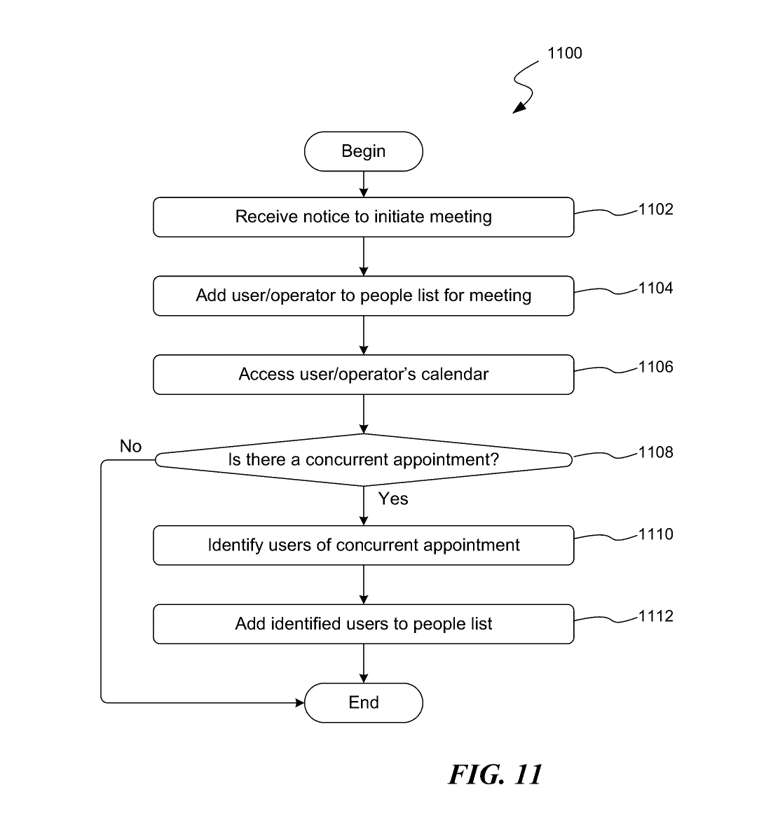

In regard to identifying persons to be displayed as being a part of a meeting, according to aspects of the disclosed subject matter the list of persons to be presented on the “annotated” note capturing screen, as shown in FIG. 8, may be determined from the calendar of that user operating the app/application on the computing device. Indeed, FIG. 11 is a flow diagram illustrating an exemplary routine 1100 for populating a people list corresponding to a particular meeting. Beginning at block 1102, notice to initiate a meeting is received. As discussed above, this notice may be received as a product of the user interacting with the “add meeting” control 606 as shown in FIG. 6. At block 1104, the user/operator is added to the people list for the current meeting. At block 1106, the user's calendar is accessed and, at decision block 1108, a determination as to whether there is a concurrent meeting in the calendar is determined. If there is no concurrent meeting, the people list is left with the user/operator of the computing device and the routine 1100 terminates. Alternatively, if there is a concurrent calendar, at block 1110, the users associated with the concurrent appointment are identified and, at block 1112, the identified users are added to the people list. Thereafter, the routine 1100 terminates.

While not shown, in addition to identifying persons associated with a concurrent appointment, the user operating the app on the computing device may also manually identify one or more persons to be presented as options in the “annotated” note capturing screen, as shown in FIG. 8. In other words, the list of persons to be presented may be user configurable, either in part or in total.

As mentioned above, it is often important to identify the person that is speaking in regard to capturing a note from an ongoing content stream. In addition to capturing the identity of the speaker and associating that identity with the captured note, those familiar with meetings will appreciate that it is often similarly desirable to associate a task with regard to a captured note and assign the task to a particular person for completion. For example, in a business meeting, an issue may arise or be discussed and a task for determining a resolution to that issue may be assigned to someone at the meeting. Indeed, it is quite frequent in meetings like that for several “action items” to be made in the course of the meeting, where each action item corresponds to a specific task assigned to a specific person. While conventionally there is someone in the meeting that is assigned to make note of the action items of the meeting, by enabling a user to capture a note from an ongoing content stream, identifying the note as a task, and associating the task with a party/person of the ongoing content stream, making a list of action items is substantially simplified. Moreover, while task assignments are quite useful in a business meeting context, the utility of assigning tasks to persons with regard to a captured note of an ongoing content stream has applicability in many other scenarios.

In regard to assigning tasks to persons/parties, FIGS. 12A-12C are pictorial diagrams illustrating an exemplary user interface on the computing device 600 of FIG. 6 in regard assigning a task to a person and associating the task with a captured note. Turning first to FIG. 12A, the user interface presented on the computing device 600 is similar to that shown in FIG. 8 (presenting the members that are present during the ongoing content stream to which the computing device is passively listening) and further including a user-actionable control 1202 for toggling the user interface between simply identifying one or more persons to be associated with a captured note (as described above) and assigning a task to a person (or persons) identified as members of the meeting and associating the task assignment with a captured note from the passive recording buffer. Indeed, as shown in FIG. 12A, with the illustrative user-actionable control 1202 in a grey-out state, by interacting with the control the “mode” switches from associating a speaker with a captured note to where the user assigns a task to one or more persons in association with a captured note. As shown in FIG. 12B, the user-actionable control 1202 is in an active state (not greyed out), indicating that a task assignment may be made in association with a note.

Turning to FIG. 12C, this pictorial diagram illustrates an exemplary user interface on the computing device 600 in which the user can assign a task to a member (or members) of the meeting. As shown in this illustrative embodiment, through the use of a “touch-drag-release” operation with regard to touching the user-actionable control 806, corresponding to “Gaurang,” and without releasing the touch dragging to the user-actionable control 808 corresponding to “Michal,” a note is generated from the passive recording buffer, a task is generated and assigned to Michal, and a speaker, “Gaurang,” is also associated with the generated note/task pair. In this manner, both a task assignment and a speaker are associated with the generated note from the passive recording buffer, generated as a result of the user interaction to assign the task to Michal.

While not shown, if the user does not wish to assign a speaker but does wish to generate a task associated with a captured note, by way of illustration the user may simply single tap on one of the members of the meeting, thereby causing a note to be captured of the ongoing content stream, a task to be associated with the note, and the task be assigned to the selected person. For example, if the user of the computing device wished to capture a note and assign a task to Gaurang with regard to the note, he/she could simply interact/tap on the user-actionable control 806. By way of additional example, if the user wished to associate a speaker with a captured note and assign a task to a note with the assignment to the same person as that identified as speaker, the user may illustratively double tap on a user-actionable control (while in the mode of task assignment). For example, by double tapping on user-actionable control 808, a note would be captured from the passive recording buffer, the speaker assigned to the note would be Michal, and a task associated with the note would be assigned Michal.

FIG. 13 is a pictorial diagram illustrating an exemplary user interface on the computing device 600 in which the user is able to view the status of the various notes associated with the meeting. As can be seen, and in contrast to FIG. 9, the title control 902 (corresponding to “Meeting 4”) now includes an additional note 1302 which indicates, via task icon 1304, that the note is assigned to “Michal.” While not shown in FIG. 13, via the user interface the user of the computing device may further inquire as to the status of the assigned task.

Of course, the various user interfaces shown in regard to FIGS. 6-9 and 12A-13 should be viewed as illustrative and not limiting upon the disclosed subject matter. Those skilled in the art will appreciate that particular arrangement of user interface may vary from that shown in the figures depending on the type and ability of user interaction with the computing device, as well as implementation preferences. Indeed, the user interfaces may be based on touch or haptic devices, mouse and/or keyboard input devices, pen or stylus based input devices, voice/audio input devices, gesture input devices, and the like. Moreover, the particular arrangement of information on the various user interfaces should also be viewed as illustrative and not limiting upon the disclosed subject matter.

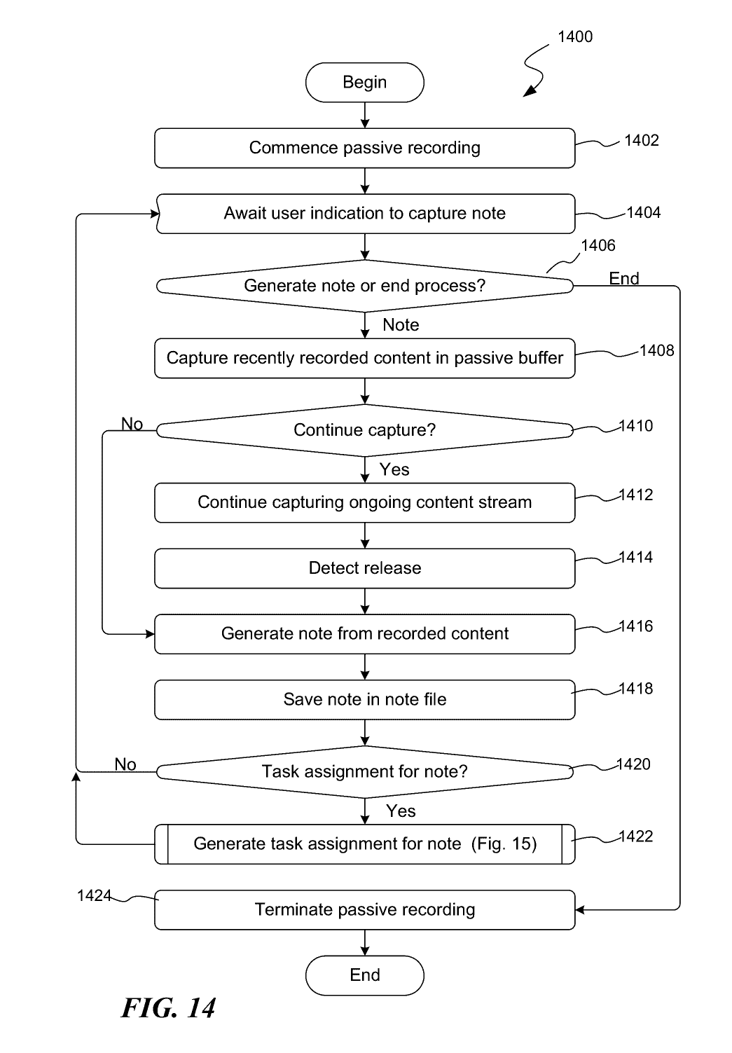

Turning to FIG. 14, FIG. 14 is a flow diagram illustrating an exemplary routine 1400 for generating notes of the most recently passively recorded content of the ongoing content stream, for continued capture until indicated by a user, and for associating a task with the note. Beginning at block 1402, a passive recording process of the ongoing audio stream is commenced. At block 1404, with the passive recording ongoing, the routine 1400 awaits a user indication to capture a note.

After receiving user instruction, at decision block 1406 a determination is made as to whether the user instruction is in regard to generating a note (from the recorded content in the passive recording buffer 102) or in regard to ending the routine 1400. If the user instruction is in regard to generating a note, at block 1408 the recently recorded content in the passive recording buffer is captured. In addition to capturing the recorded content from the passive recording buffer, at decision block 1410 a determination is made in regard to whether the user has indicated that the routine 1400 should continue capturing the ongoing audio stream for transcription as an expanded note. If the determination is made that the user has not indicated that the routine 1400 should continue capturing the ongoing audio stream, the routine proceeds to block 1416 as described below. However, if the user has indicated that the routine 1400 should continue capturing the ongoing audio stream as part of an expanded note, the routine proceeds to block 1412. At block 1412, without interrupting the passive recording process, the ongoing recording of the ongoing content stream to the passive recording buffer is continually captured as part of expanded captured recorded content, where the expanded captured recorded content is, thus, greater than the amount of recorded content that can be stored in the passive recording buffer.

At block 1414, this continued capture of the content stream continues until an indication from the user is received to release or terminate the continued capture. At block 1416, after capturing the recently recorded content in the passive recording buffer and any additional content as indicated by the user, a note is generated from the captured recorded content. According to various embodiments, the note may be generated according to a transcription of the recorded/captured content. Alternatively, a note may be generated as a single audio file from the recorded/captured content. Further still, a note may be stored in a note file in multiple formats, such as an audio file and a transcription.

At block 1418, the generated note is then stored in a note file, i.e., a data file comprising at least one or more text notes. As indicated above, according to various embodiments, the note may be stored in a note file in association with (or as part of) a meeting. At block 1420, a determination is made as to whether the identity of a person is to be associated with the generated note, i.e., whether to annotate the note with the identity of one or more persons. If the note is not to be annotated with the identity of one or more persons, the routine 1400 returns to block 1404 to await additional user instructions. Alternatively, if the generated note is to be annotated with the identity of one or more persons, the routine 1400 proceeds to block 1422.

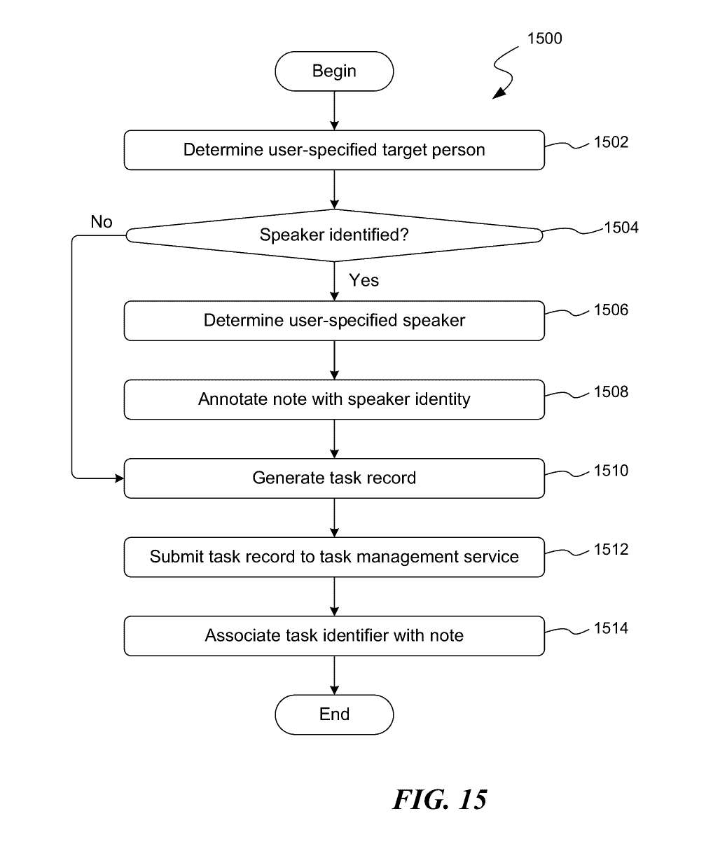

At block 1422 the generated note is annotated or associated with a task assignment, as described in regard to FIG. 15. Indeed, FIG. 15 is a flow diagram illustrating an exemplary routine 1500 for associating a task assignment with a generated note. Beginning at block 1502, the target person of the task assignment, as specified by the user via the user interface, is determined. Additionally, at block 1504, a determination is made as to whether a speaker was also identified by the user. If a speaker was identified by the user, at block 1508 the generated note is annotated with the speaker's identity.

If the speaker was not included/identified, or after annotating the note with the speaker's identity, at block 1510 a task record is generated. The task record comprises information regarding the assigned person's identity, the generated note, the originator of the task (corresponding to the user initiating the capture of the note and task assignment), as well as other information regarding the note that may be of relevance to the assigned person. At block 1512, the task record is submitted to (i.e., assigned to the target user via) the task management service, as described above. Indeed, as indicated above, the task management service sends the task to the target person and provides status tracking for this and any other tasks that the user has assigned. Moreover, in return from submitting the task record, a task identifier is returned and, at block 1514, the task identifier is associated with the generated note. Thereafter, the routine 1500 terminates.

Returning again to routine 1400, after generating a task assignment for the captured note, the routine 1400 returns to block 1404 to await additional user instructions.

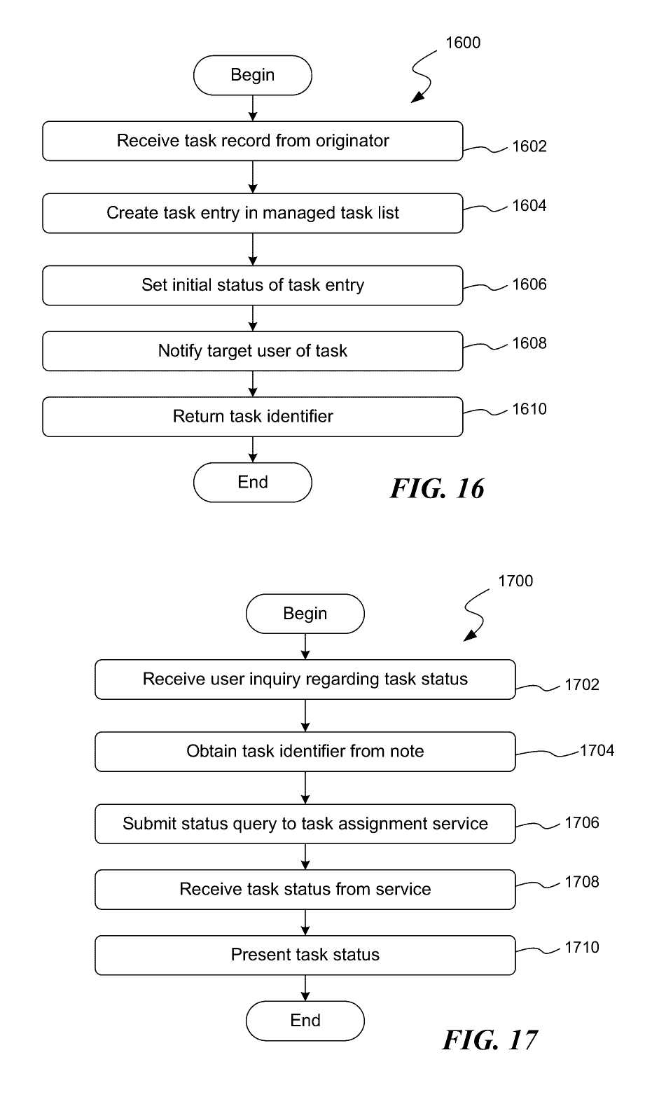

In regard to the task management service, FIG. 16 is a flow diagram illustrating an exemplary routine 1600 for a task management service to respond to a task record submission, as described in routine 1500. As indicated above, the task record includes the target user (the person that is assigned the task), the generated note, and the originator. Additionally the task record may include a speaker associated with the task, as well as other information regarding the note and task. Beginning at block 1602, a task management service, such as task management service 512, receives a task record corresponding to a task assignment associated with a note. At block 1604, a task entry (such as task entry 446 or 444) is created in a managed task list 440. According to aspects of the disclosed subject matter, task management service 438 maintains the managed task list comprising managed tasks (corresponding to generated notes) such that the originator of a task can monitor the completion status of the task.

At block 1606, the initial status of the task entry is set and, at block 1608, the target user of the task is notified of the task. According various embodiments of the disclosed subject matter, the notification includes the information from the task record including, by way of illustration and not limitation, the generated note, the originator, a speaker (if available), and the like. After notifying the target user, a task identifier corresponding to the this task is returned. As indicated above, the task identifier may be used to identify the task in the task list such that the originator may determine the status of the assigned task. Thereafter, the routine 1600 terminates.

Turning now to FIG. 17, this figure is a flow diagram illustrating an exemplary routine 1700 for enabling an originating user to determine the status of a task managed by a task management service. Beginning at block 1702, a request regarding the status of a task associated with a note is received. At block 1704, the task identifier associated with the note is obtained. At block 1706, a status request based on the task identifier is submitted to the task management service. At block 1708, information regarding the task status is received and, at block 1710 the status of the task is presented. Thereafter, routine 1700 terminates.

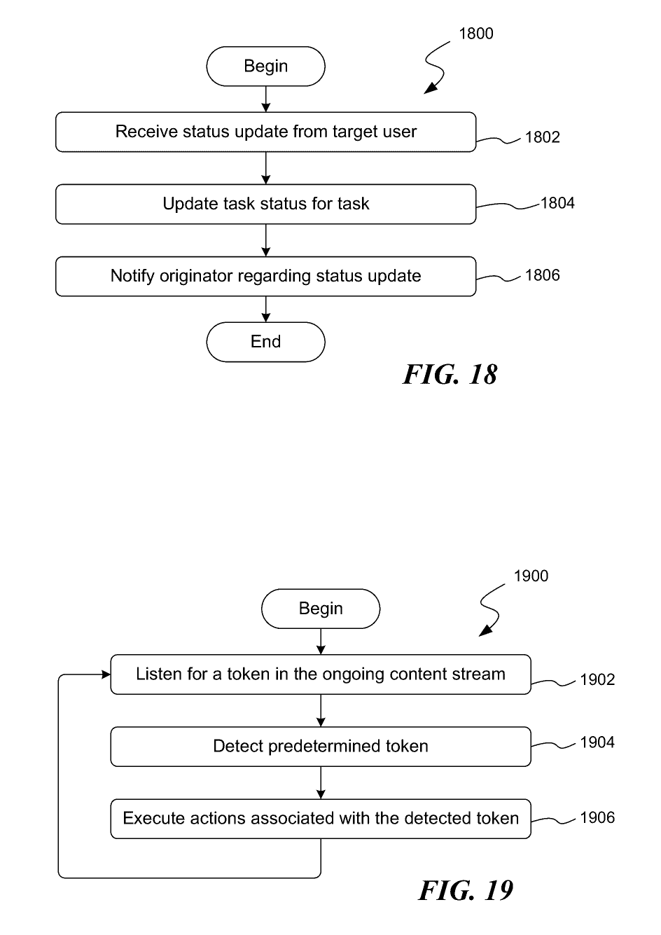

In regard to the status of a managed task, when a task is sent to a target person, that task includes information on how to update the status with regard to the task management service. For example, the task may include a preconfigured hyperlink that, upon activation, simply sends a message to the task management service that the task is completed. Alternatively, one or more code modules may be included with the task to notify the task management service that the task is completed. Still further, the task may be associated with a person's “to do” list and include a user-actionable control for sending a response to the task management service that the corresponding task is completed. In regard to receiving a completed status, FIG. 18 is a flow diagram illustrating an exemplary routine 1800 for updating the status of a task in its managed task list. Beginning at block 1802, a status update in regard to a managed task is received. The status update will include a task identifier for identifying which task has been completed. At block 1804, the task status of the task is updated. According to aspects of the disclosed subject matter, a status may include one of several values including, by way of illustration and not limitation, assigned, in progress, completed, and the like. After updating the status of the task identified by the status update, a notification of the status update may optionally be sent to the task originator. Thereafter, the routine 1800 terminates.

In addition to relying upon the user to indicate that a note should be generated from the passive recording buffer and a task (or a person) associated with the note, according to additional aspects and embodiments of the disclosed subject matter, notes may be automatically generated according to detected elements of the content of the ongoing content stream and these notes may be associated with a speaker, annotated with a category or an image, assigned a task, and/or processed according to various, additional user defined rules.

According to one embodiment of the disclose subject matter, in addition to monitoring for a user indication to capture the content in the passive recording buffer and generate a corresponding note, the process for passively recording the ongoing content stream is further configured to detect predetermined words, phrases and/or conditions, referred to generally as “features”, and carry out one or more actions associated with the detected feature. According to an alternative embodiment, a cooperative process, i.e., not the passive recording process for capturing the ongoing content stream but, rather, an additional process that operates in parallel with the passive recording process, also monitors the ongoing content stream listening for predetermined features and, upon detecting a predetermined feature, carries out one or more actions associated with the detected feature. These actions may include automatically capturing a note from the passive recording buffer, obtaining confirmation to capture a note from the passive recording buffer, configuring various conditions with regard to an automatically captured note or a potentially captured note (i.e., identify a speaker and/or category, place the device in condition to capture a photograph, indicate a task assignment, and the like), etc. For purposes of simplicity in description, the following discussion with be made in regard to the feature detection as the separate, cooperative process to the process for passively recording the ongoing content. However, the discussion with regard to the feature detection as a cooperative process is equally applicable to a suitably configured passively recording the ongoing content.

Turning to FIG. 19, FIG. 19 is a flow diagram illustrating an exemplary routine 1900 implementing a feature monitoring process for monitoring an ongoing content stream for a predetermined feature and, upon detecting the predetermined feature, taking a corresponding action. Beginning at block 1902, the feature monitoring process begins listening to the ongoing content stream for one or more predetermined features. As indicated above, a “feature” corresponds to a spoken word or phrase. For example, a predetermined feature may correspond to the spoken words of “assign you with” and, upon detecting this phrase in the ongoing content stream, execute actions associated with the feature. Alternatively, a predetermined feature may correspond to a detected condition, such as a particular person speaking in the course of the ongoing content stream. Still further, a predetermined feature may correspond to a detected sound or some other element of the ongoing content stream.

At block 1904, a predetermined feature (of a set of one or more predetermined features) is detected. At block 1906, one or more actions associated with the detected predetermined feature are executed. These actions may include (by way of illustration and not limitation), automatically capturing a note from the passive recording buffer of the ongoing content stream, assigning a task associated with a note to one or more persons in the meeting, automatically identifying the speaker and associating the speaker with a note, automatically identifying a category to be assigned to a note, executing one or more applications/apps, the like. In regard to automatically capturing a note from the passive recording buffer, the associated actions may include a length of time with regard to the amount of content that the user wishes to capture in the generated note. For example, in addition to automatically generating a note from the content in the passive recording buffer (as well as other actions), an associated action may cause the capture process to continue capturing the ongoing content stream for a specified period of time into the generated note. Additionally, if a note is not automatically generated, an associated action may include requesting a user confirmation with preset conditions such as identifying the speaker, category, potential task assignment, and/or execution of one or more apps/applications, may be configured into a suggestion presented to the user of the computing device for confirmation, where user confirmation causes a note to be generated from the passive recording buffer of the ongoing content stream and the preconfigured conditions associated/executed with the generated note.

After executing the associated actions, the routine 1900 returns again to block 1902 to listen for additional predetermined features. According to various embodiments, the routine 1900 terminates when the passive recording process is terminated.

In addition to the feature detection process, an additional feature identification process may also be operating on the computing device. While the feature detection process is configured to detect predetermined features from the ongoing content stream and take a corresponding action with regard to the detected features, the feature identification process is directed to identifying potential new features that may be of use to the user and/or in improving or refining the actions associated with a predetermined feature. Indeed, upon detecting that the user of the computing device has causes a note to be generated from the passive recording buffer, the feature identification process examines the content of the captured content to identify potential features that may have motivated the user to cause the note to be generated. Over a period of time and through the use of machine learning techniques, the feature identification process is able to identify and suggest features to be added to the predetermined features based on the observations from the notes that are generated by the user, as well as the corresponding actions to be taken with regard to the features.

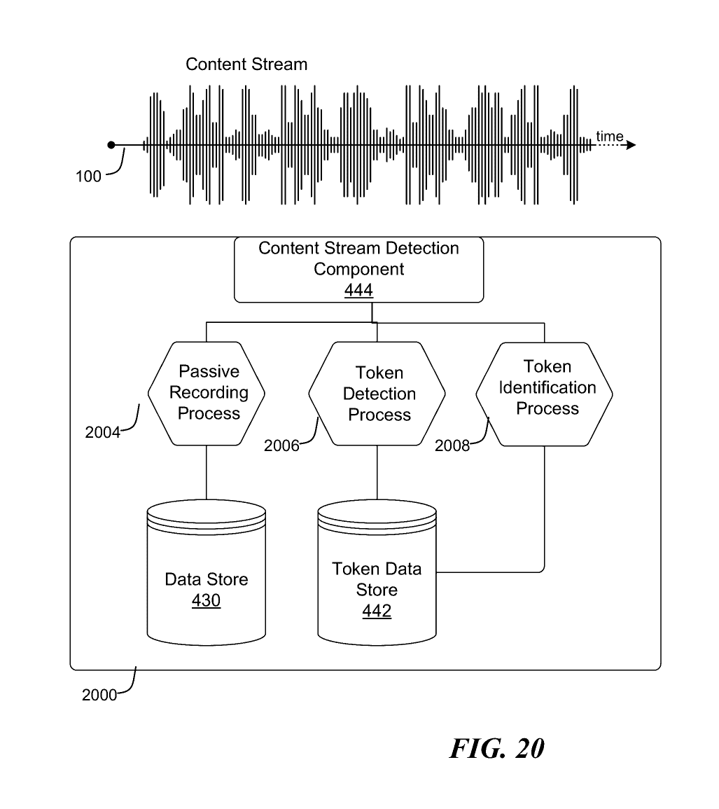

FIG. 20 is a block diagram illustrating exemplary processes executing on a computing device (such as computing device 400) and executing in regard to an ongoing content stream. As shown in FIG. 20, various processes, including a passive recording process 2004, a feature detection process 2006, and a feature identification process 2008 are executing on a computing device 2000 in regard to an ongoing content stream 100 by way of a content stream detection component 444. As discussed above, the passive recording process 2004 passively records the ongoing content stream 100 in a passive recording buffer. Additionally, according to aspects of the disclosed subject matter, the feature detection process 2006 is listening to the ongoing content stream 100, via the content stream detection component 444 for one or more features defined in a feature data store 442. As indicated above, upon detecting a feature in the ongoing content stream, the feature detection process executes one or more actions associated with the detected feature. The feature identification process is monitoring the activity of the user in regard to generating notes and executing instructions in regard to the captured note and applying machine learning techniques in an effort to identify one or more potential features and corresponding actions that the user may wish to add to the list of predetermined features (and corresponding actions).

While various novel aspects of the disclosed subject matter have been described, it should be appreciated that these aspects are exemplary and should not be construed as limiting. Variations and alterations to the various aspects may be made without departing from the scope of the disclosed subject matter.

What is claimed:

1. A computer-implemented method conducted on a user's computing device, comprising at least a processor and a memory, for executing an action with regard to a detected feature in an ongoing content stream, the method comprising:
passively recording an ongoing content stream, the passive recording storing recorded content of the ongoing content stream in a passive recording buffer;
monitoring for a predetermined feature in the ongoing content stream;
detecting the predetermined feature in the ongoing content stream; and
executing an action associated with the predetermined feature with regard to the recorded content of the ongoing content stream in the passive recording buffer.

2. The computer-implemented method of claim 1, wherein detecting the predetermined feature in the ongoing content stream comprises detecting a spoken word in the ongoing content stream.

3. The computer-implemented method of claim 1, wherein detecting the predetermined feature in the ongoing content stream comprises detecting a spoken phrase in the ongoing content stream.

4. The computer-implemented method of claim 1, wherein detecting the predetermined feature in the ongoing content stream comprises detecting a plurality of conditions in the ongoing content stream, the plurality of conditions comprising any one or more of a pattern of speech, a speed of speech, a tone of speech, volume, an identified speaker, a relationship of one word or phrase detected in the ongoing content stream with regard to another word or phrase, a timing of words in the ongoing content stream, and a part of speech used with regard to a particular word in the ongoing content stream.

5. The computer-implemented method of claim 4, wherein executing an action associated with the predetermined feature comprises automatically generating a note from the recorded content of the ongoing content stream in the passive recording buffer.

6. The computer-implemented method of claim 5, wherein executing an action associated with the predetermined feature further comprises configuring one or more aspects of a note and automatically generating the note from the recorded content of the ongoing content stream in the passive recording buffer.

7. The computer-implemented method of claim 6, wherein the one or more aspects of a note comprises establishing a speaker associated with the note.

8. The computer-implemented method of claim 6, wherein the one or more aspects of a note comprises annotating the note with a category.

9. The computer-implemented method of claim 6, wherein the one or more aspects of a note comprises associating a task for a speaker with the note.

10. The computer-implemented method of claim 4, wherein executing an action associated with the predetermined feature comprises configuring one or more aspects of a note for confirmation and generation by the user with regard to the recorded content of the ongoing content stream in the passive recording buffer.

11. The computer-implemented method of claim 10, wherein the one or more aspects of a note comprises establishing a speaker associated with the note.

12. The computer-implemented method of claim 10, wherein the one or more aspects of a note comprises annotating the note with a category.

13. The computer-implemented method of claim 10, wherein the one or more aspects of a note comprises associating a task for a speaker with the note.

14. A computer-readable medium bearing computer-executable instructions which, when executed on a computing system comprising at least a processor, carry out a method for executing an action with regard to a detected feature in an ongoing content stream, the method comprising:
passively recording an ongoing content stream, the passive recording storing recorded content of the ongoing content stream in a passive recording buffer;
monitoring for a predetermined feature in the ongoing content stream;
detecting the predetermined feature in the ongoing content stream; and
executing an action associated with the predetermined feature with regard to the recorded content of the ongoing content stream in the passive recording buffer.

15. The computer-readable medium of claim 14, wherein detecting the predetermined feature in the ongoing content stream comprises any one of detecting a spoken word in the ongoing content stream or detecting a spoken phrase in the ongoing content stream.

16. The computer-readable medium of claim 14, wherein detecting the predetermined feature in the ongoing content stream comprises detecting a spoken phrase in the ongoing content stream.

17. The computer-readable medium of claim 14, wherein detecting the predetermined feature in the ongoing content stream comprises detecting a plurality of conditions in the ongoing content stream, the plurality of conditions comprising any one or more of a pattern of speech, a speed of speech, a tone of speech, volume, an identified speaker, a relationship of one word or phrase detected in the ongoing content stream with regard to another word or phrase, a timing of words in the ongoing content stream, and a part of speech used with regard to a particular word in the ongoing content stream.

18. The computer-readable medium of claim 14, wherein executing an action associated with the predetermined feature further comprises configuring one or more aspects of a note and automatically generating the note from the recorded content of the ongoing content stream in the passive recording buffer.

19. A user computing device for executing an action with regard to a detected feature in an ongoing content stream, the computing device comprising a processor and a memory, wherein the processor executes computer-executable instructions stored in the memory as part of or in conjunction with additional components, the additional components comprising:
a passive recording buffer, the passive recording buffer configured to temporarily store a predetermined amount of recorded content of an ongoing content stream;
an audio recording component, the audio recording component being configured to generate recorded content of the ongoing content stream;
a passive recording component, the passive recording component being configured to obtain recorded content of the ongoing content stream from the audio recording component and store the recorded content to the passive recording buffer; and
a feature detection component, the feature detection component being configured to detect a predetermined feature in the ongoing content stream and, upon detecting the predetermined feature, execute an action associated with the predetermined feature with regard to the recorded content of the ongoing content stream in the passive recording buffer.

20. The user computing device of claim 19, wherein executing an action associated with the predetermined feature further comprises configuring one or more aspects of a note and automatically generating the note from the recorded content of the ongoing content stream in the passive recording buffer.
